(19) United States
(12) Patent Application Publication
(10) Pub. No.: US 2010/0266653 A1
(43) Pub. Date: Oct. 21, 2010

(54) BIOCIDAL POLYACROLEIN COMPOSITION

(75) Inventors: Robert William Dunlop, Shenton Park (AU); Gautam Dalwadi, Victoria Park (AU)

Correspondence Address: NIXON PEABODY LLP - PATENT GROUP, 1100 CLINTON SQUARE, ROCHESTER, NY, 14604, US

(73) Assignee: CHEMEQ LTD, Subiaco, WA (AU)

(21) Appl. No.: 12/669,281

(22) PCT Filed: Jul. 18, 2008
(86) PCT No.: PCT/AU2008/001032

§ 371 Date: Jun. 24, 2010

Related U.S. Application Data
(60) Provisional application No. 60/929,961, filed on Jul. 19, 2007.

(51) Int. Cl. A01N 43/90; A01N 25/02; A01N 25/10; A01P 1/00; A01N 25/12

(52) U.S. Cl. 424/405; 424/78.38; 424/409; 428/402

(57) ABSTRACT

This invention relates to a biocidal composition comprising fine particles comprising polyacrolein wherein at least 90% of particles are of a size no more than 30 microns. Preferably at least 90% of particles are of size no more than 5 microns and still more preferably at least 90% of particles are of size no more than 1 micron.

This application is a national stage application under 35 U.S.C. §371 from PCT Application No. PCT/AU2008/001032, filed Jul. 18, 2008, which claims the priority benefit of U.S. Provisional Application Ser. No. 60/929,961, filed Jul. 19, 2007.

This application claims the benefit of priority from U.S. Provisional 60/929,961 (19 Jul. 2007) the contents of which are herein incorporated by reference.

### FIELD

This invention relates to a biocidal polyacrolein composition, to a method of preparing a biocidal polyacrolein composition and to a process for controlling microbial growth using the composition.

### BACKGROUND

The biocidal properties of polyacrolein are discussed in U.S. Pat. No. 5,290,894. The poor physical stability of compositions of polyacrolein in water make it difficult to formulate. These problems are reportedly overcome by including hydrophilic comonomers. U.S. Pat. No. 6,723,336 discloses a water soluble polyacrolein which is useful in treating gastrointestinal disease in animals. Our U.S. Pat. Nos. 6,803,356 and 6,410,040 also disclose methods of improving the solution stability and antimicrobial activity of polyacrolein by modifying the polymer to include acid groups and optionally further reacting the polymer to form acetal groups.

### SUMMARY

We have now found that polyacrolein in the form of finely divided particles of size no more than 30 microns, preferably no more than 5 microns and still more preferably no more than 1 micron form a stable dispersion in water and have a high level of biocidal activity.

Accordingly we provide a biocidal composition comprising fine particles comprising polyacrolein wherein at least 90% by weight of particles are of a size no more than 30 microns. Preferably at least 90% by weight of particles are of size no more than 5 microns and still more preferably at least 90% of particles are of size no more than 1 micron.

In one embodiment the composition is in the form of an aqueous suspension comprising suspended particles comprising polyacrolein of the above referred particle size.

In a further embodiment the invention provides a biocidal composition comprising water dispersible particles comprising a particulate water soluble material and associated there with biocidal particles comprising polyacrolein wherein at least 90% by weight of particles are of a size no more than 30 microns. Preferably at least 90% by weight of particles are of size no more than 5 microns and still more preferably at least 90% by weight of particles are of size no more than 1 micron.

The invention further provides a method of preparing a particulate biocide containing polyacrolein in accordance with the above defined composition, the method comprising:

(i) forming a solution of polyacrolein in a solvent at least partly soluble in water; and
(ii) mixing the solution of polyacrolein with an aqueous composition to provide a fine suspension of polyacrolein particles in the aqueous composition.

The invention further provides a method of preparing a particulate polyacrolein biocidal composition comprising milling polyacrolein to reduce the particle size so that at least 90% of particles are of a size no more than 30 microns. Preferably at least 90% of particles are of size no more than 5 microns and still more preferably at least 90% of particles are of size no more than 1 micron.

### DETAILED DESCRIPTION

The polyacrolein particles in accordance with the invention comprise at least 90% by weight of particles which are of a size no more than 30 microns. Preferably at least 90% by weight of particles are of size no more than 5 microns and still more preferably at least 90% by weight of particles are of size no more than 1 micron. The polyacrolein particles are typically of size of at least 5 nm more preferably at least 10 nm and most preferably at least 20 nm. The optimum particle size depends to a certain extent on the application in which the composition is to be used however typically from an activity perspective the more preferred size provides at least 90% by weight of particles of size no more than 200 nm and most preferably no more than 150 nm. We have found that the activity of particles in the nanoparticle range (up to 1000 nm), more preferably no more than 200 nm and particularly up to 150 nm is significantly improved.

The polyacrolein may be an acrolein homopolymer or copolymer comprising, for example up to 15% and preferably no more than 10% by weight of monomers other than acrolein. Most preferably the polyacrolein is an acrolein homopolymer.

The polyacrolein may be formed by radical polymerization, anionic polymerization or based catalysed polymerization. We have found that polyacrolein particles comprising polyacrolein formed by base catalysis exhibit superior activity particularly when compared with polyacrolein prepared by radical polymerization.

The polyacrolein particles may be oxidized so as to modify the polymer to include a select proportion of acid groups such as from 0.5 to 5 mole carboxylic acid groups per kilogram of polymer. The incorporation of acid groups by oxidation of a solid in air or other source of oxygen is described, for example in our U.S. Pat. No. 6,723,336 in Example 1b.

In one aspect the invention provides a method of preparing a particulate polyacrolein biocidal composition in accordance with the above the method comprising

(i) forming a solution of polyacrolein in a solvent at least partially soluble in water; and
(ii) mixing the solution of polyacrolein with an aqueous composition to provide a fine suspension of polyacrolein particles in the aqueous composition The process provides the particulate polyacrolein in the form of a nano suspension. The nanoparticles may if desired be collected from the nano suspension but generally speaking it is preferred in this embodiment for the aqueous nanosuspension to be used in formulation of the biocide optionally with addition of suitable excipients and adjuvants for the desired application. The solvent is preferably at least partly soluble in water. Typically it will have a solubility in water of at least 1% at 20° C. Examples of suitable solvents include aliphatic and aromatic alcohols and ethers and mixtures of two or more thereof where the solvent composition has the required solubility. Specific examples include C₁ to C₄ alkanols, benzyl alcohol, polyols such as polyethylene glycol and propylene glycol and ethers such as tetrahydrofuran

The invention further provides a method of preparing a particulate polyacrolein biocidal composition comprising milling a solid comprising polyacrolein to reduce the particle size so that at least 90% of particles are of a size no more than 30 microns. Preferably at least 90% of particles are of size no more than 5 microns and still more preferably at least 90% of particles are of size no more than 1 micron.

The milling may be carried out using various known equipment such as ball mills attrition mill, fluid energy mills and the like. Fluid energy mills are particularly preferred. Milling may be carried out on the solid or a dispersion of the solid in a suitable liquor such as water (in which the solid is insoluble) or a suitable oil.

The polyacrolein will typically be milled from a composition having a particle size greater than 5 microns, preferably greater than 50 microns and most preferably greater than 100 microns to provide a particle size wherein at least 90% of particles are of size no more than 5 microns and still more preferably at least 90% of particles are of size no more than 1 micron.

In a particularly preferred embodiment of the invention the particulate biocide is formulated as a water dispersible granular or water dispersible powder formulation. Such a formulation may include additives such as dispersants, surfactants, fillers such as clays and metal salts, water soluble materials, thickeners and the like. In one embodiment the particulate polyacrolein is adsorbed onto a carrier which is preferably a water soluble particulate carrier such as selected from the group consisting of saccharides, sugar alcohols and water soluble salts such as sodium chloride. Specific examples of sugar and sugar alcohol carriers include lactose, mannose, sucrose, maltose, sorbitol, manitol. Particulate lactose is particularly preferred. Typically the solid particulate carrier for the particulate polyacrolein has a particle size substantially greater than the polyacrolein particles. The water soluble particulate carrier may, for example have a particle size in the range of from 30 to 2000 microns and more preferably from 50 to 500 microns.

The polyacrolein will typically comprise at least 10%, preferably at least 25%, still more preferably 50% and most preferably at least 80% by weight of polyacrolein based on the total weight of the particulate biocide composition. The particulate biocide composition may be part of a water dispersible composition in which case it will typically constitute in the range of from 1 to 99% by weight and preferably from 1 to 20% by weight of the total water dispersible composition.

The compositions of the invention have a number of antimicrobial uses. They are useful in (a) animal feed to treat or reduce the incidence of gastrointestinal disease; (b) in antiseptic and disinfectant preparations; (c) in fungicides in treating or preventing fungal infestation in wood, soil, building materials or plants; (d) as preservatives in cosmetic and pharmaceuticals; and (e) as water treatment preparations for water filters, water cooling towers, water remediation and treatment of domestic or industrial water supplies.

The invention will now be described with reference to the following examples. It is to be understood that the examples are provided by way of illustration of the invention and that they are in no way limiting to the scope of the invention.

### EXAMPLES

Particle size analysis has been determined using Dynamic Light Scattering with laser diffraction in which method, particle sizes of a dilute suspension of the solid in water are measured between 0.02 and 2000 um.

### Example 1

### Part (a)

This Example relates to preparation of a particulate polyacrolein of one aspect in accordance with the invention by a method in accordance with a further aspect of the invention in which a solution of polyacrolein in a water soluble liquid is added to an aqueous composition.

The polyacrolein used in this Example was prepared in accordance with Example 1b of U.S. Pat. No. 6,723,336 and was in the form of an oxidized particulate poly(2-propenal, 2-propenoic acid) comprising in the range of from 0.5 to 5 moles of carboxyl groups per kilogram of polyacrolein.

The particulate starting material comprised particles of size of about 10 to 2000 microns and was insoluble in water.

A 20% w/w solution of poly(2-propenal, 2-propenoic acid) in benzyl alcohol was prepared by stirring the mixture at 65° C. and the stirred mixture allowed to cool to room temperature to provided a clear viscous solution. A small volume of ethanol was added and the mixture was added slowly to a vigorously stirred volume of water. The resulting composition was in the form of a nanoparticles of poly(2-propenal, 2-propenoic acid) dispersed in an aqueous mixture and appeared as a transparent mixture of milky appearance.

### Part (b)

This Example examines the biocidal properties of a nanoparticulate dispersion of poly(2-propenal, 2-propenoic acid)

The 20% solution of poly(2-propenal, 2-propenoic acid) in benzyl alcohol (97.98 mg) was mixed with absolute ethanol (500 μL) and the mixture added to stirred water (6.9 g) in a glass vial. The resulting suspension was backwashed. The final weight was made up with water to 9.979 g (ie 2000 ppm active).

As a control sample benzyl alcohol (82.4 ml) and ethanol (500 μL) were combined and transferred to water (74 g) and made up to 10 g with water. Both active and control samples were subject to antimicrobial testing.

| Sample | MIC (E. coli) |
|---|---|
| Invention | 62.5 ppm |
| Control | 1000 ppm |

### Example 2

### Part (a)

A sample poly(2-propenal, 2-propenoic acid) of particle size of about 10 to 2000 microns was milled using a fluid energy mill to provide a particle size less than 5 microns with the majority of the sample by weight having a particle size of less than 1 micron. The fluid energy or jet mill produces size reduction as a result of high velocity collisions between particles of the process material. The interior of the chamber allows recirculation of oversized particles.

### Part (b)

### Preparation of Feed Mixture

Finely divided particulate poly(2-propenal, 2-propenoic acid) produced according to the process of claim 1 were mixed with granular pig feed using a Tumble or Turbula mixer. The particulate poly-propenal, 2-propenoic acid) was rapidly distributed onto the surface of animal feed granules. There was little if any difference in appearance between the pig feed with and without the added antimicrobial active.

### Part (c)

### Absorption onto Water Soluble Carrier

Micronised poly(2-propenal, 2-propenoic acid prepared according to Part a was adsorbed onto water soluble solid carrier using the components and process described below.

Microsuspension

| Component | Amount |
|---|---|
| Micronised poly (2-propenal, 2-propenoic acid) | 5.0 g |
| Lactose (AR grade) | 5.0 g |
| Carrageenan Type II | 1.0 g |
| Sodium Chloride | 1.0 g |
| Glycerin 3% w/w q.s | 100.0 ml |

Carrageenan (a sulfated polysaccharide extracted from seaweeds) and sodium chloride were triturate together to a fine size in a mortar (approximately <100 um), then added gradually with stirring (speed 5) to 70 ml of 3% glycerin solution. After 45 minutes of stirring this gave very fine dispersion, with no lump. (Appearance was transparent—slight milky).

Micronised poly(2-propenal, 2-propenoic acid) and lactose were also triturated together in a separate mortar and added to above dispersion with stirring (speed 7). After complete addition the mortar was washed with 20 ml of the 3% glycerin solution that was added to above dispersion.

Rest of 10 ml of 3% glycerin was used to wash the fine powder adhere on the edges of the main containers that splashed during the addition.

The stirring wash continued for another two hours to ensure complete mixing.

Finally, it is understood that various other modifications and/or alterations may be made without departing from the spirit of the present invention as outlined herein.

1. A biocidal composition comprising fine biocidal particles comprising polyacrolein wherein at least 90% by weight of the particles comprising polyacrolein are of a size no more than 30 microns.

2. A biocidal composition according to claim 1 wherein at least 90% by weight of particles are of size no more than 5 microns.

3. A biocidal composition according to claim 1 wherein the composition is in the form of an aqueous suspension comprising the fine particles of polyacrolein.

4. A biocidal composition according to claim 1 wherein the particles are solid particles and have been reduced in size by milling from a particle size greater than 10 microns.

5. A biocidal composition according to claim 1 further comprising water dispersible particles comprising a particulate water soluble material with which the fine particles comprising polyacrolein are associated.

6. A biocidal composition according to claim 1 wherein 90% by weight of biocide particles are of size no more than 200 nm.

7. A biocidal composition according to claim 1 wherein the polyacrolein is selected from the group consisting of acrolein homopolymers and copolymers comprising no more than 10% by weight of monomers other than acrolein.

8. A biocidal composition according to claim 1 wherein the polyacrolein is oxidized so as to modify the polymer to include from 0.5 to 5 mole carboxyl groups per kilogram of polymer.

9. A biocidal composition according to claim 1 wherein the particulate biocide composition comprises at least 25%, by weight of polyacrolein based on the total weight of the particle composition.

10. A biocidal composition according to claim 5 wherein the solid particulate carrier for the particulate biocide has a particle size substantially greater than the biocide particles comprising polyacrolein.

11. A biocidal composition according to claim 10 wherein the particulate carrier has a particle size in the range of from 30 to 2000 microns.

12. The biocidal composition according to claim 5 wherein the formulation includes one or more additives selected from the group consisting of dispersants, surfactants, fillers, clays, metal salts, water soluble materials, and thickeners.

13. A biocidal composition according to claim 5 wherein the particulate biocide comprising polyacrolein is adsorbed onto a water soluble particulate carrier selected from saccharides, sugar alcohols and water soluble salts.

14. A method of preparing a particulate polyacrolein biocidal composition according to claim 1 comprising milling a solid comprising polyacrolein to reduce the particle size so that at least 90% by weight of particles are of a size no more than 30 microns.

15. A method according to claim 14 wherein the solid is milled to provide at least 90% by weight of particles are of size no more than 5 microns.

16. A method according to claim 14 wherein milling is carried out on the solid or a dispersion of the solid in a liquor in which the particulate polyacrolein is insoluble.

17. A method according to claim 14 wherein the biocide comprising polyacrolein is milled from a composition having a particle size greater than 50 microns to provide a particle size wherein at least 90% by weight of particles are of size no more than 5 microns.

18. A method of preparing a particulate biocide containing polyacrolein in accordance with claim 1 the method comprising:
(i) forming a solution of polyacrolein in a solvent at least partly soluble in water; and
(ii) mixing the solution of polyacrolein with an aqueous solution to provide a fine suspension of polyacrolein particles in the aqueous composition.

19. A biocidal composition according to claim 6 wherein the biocide particles are of a size no more than 150 nm.
